(19) United States
(12) Patent Application Publication
(10) Pub. No.: US 2021/0104951 A1
(43) Pub. Date: Apr. 8, 2021

(54) SWITCHING POWER SUPPLY DEVICE

(71) Applicants: Yasumichi Omoto, Aichi (JP); Dachao Wang, Aichi (JP)

(72) Inventors: Yasumichi Omoto, Aichi (JP); Dachao Wang, Aichi (JP)

(73) Assignee: NIDEC MOBILITY CORPORATION, Aichi (JP)

(21) Appl. No.: 17/060,716

(22) Filed: Oct. 1, 2020

(30) Foreign Application Priority Data
Oct. 8, 2019 (JP) 2019-185140

(51) Int. Cl. H02M 3/335; H02M 1/088

(52) U.S. Cl. CPC H02M 3/33569; H02M 2001/0009; H02M 1/088

(57) ABSTRACT

A switching power supply device includes: a converter; an input voltage detecting unit configured to detect an input voltage of the converter; a current detecting unit configured to detect at least one of an input current and an output current of the converter; a dead time setting unit configured to set a dead time in on/off operations of switching elements of the converter; and a dead time table in which the dead time is recorded for each input voltage value and each output current value on a matrix formed by input voltage values and output current values. The dead time setting unit sets the dead time with reference to the dead time table based on the input voltage detected by the input voltage detecting unit and the current detected by the current detecting unit.

### CROSS-REFERENCE TO RELATED APPLICATIONS

This application is based upon and claims the benefit of priority from Japanese Patent Application No. 2019-185140, filed on Oct. 8, 2019, the entire contents of which are incorporated herein by reference.

### FIELD

One or more embodiments of the present invention relate to a switching power supply device having a converter for converting an input voltage to a predetermined voltage, in particular, to a technique for reducing switching loss.

### BACKGROUND

For example, an electric vehicle or a hybrid car is equipped with a high-voltage battery for driving a traveling motor, and a power supply device for stepping down the voltage of the battery to supply to each unit. As the power supply device, a switching power supply device having a DC-DC converter for switching a DC voltage to convert it into an AC voltage, and rectifying the AC voltage to convert it into a DC voltage of a predetermined voltage value is generally used. A typical DC-DC converter is configured with a full-bridge type switching circuit having four switching elements, a transformer having the switching circuit connected to a primary side, and a rectifier circuit connected to a secondary side of the transformer, and the like.

In the DC-DC converter, when switching loss occurs during on/off operations of the switching element, power conversion efficiency is reduced. The switching loss is a loss occurred due to presence of a period in which both a current and a voltage of the switching element do not become zero in a transient state in which the switching element switches from on to off or from off to on. A driving method called soft switching (Soft Switching) is known as an effective means for reducing the switching loss, and a method called zero volt switching (Zero Volt Switching) is provided as one of the driving methods. The zero volt switching is a method of controlling so that, for example in a case where the switching element is a field effect transistor (FET), the FET is turned on when the voltage between a drain and a source becomes zero volts and current flows through the FET.

On the other hand, in the case of the full-bridge type switching circuit, when a pair of upper and lower switching elements connected in series are turned on at the same time at the time of on/off switching, a short circuit occurs between input terminals and a large current flows. Thus, in order to avoid this, a period in which both switching elements are turned off is provided between one switching element being turned off and the other switching element being turned on. This period is called a “dead time”. In order to make the above soft switching effective, it is necessary to set the dead time to an optimum value. When the dead time is too short or too long, neither the current nor the voltage of the switching element becomes zero in the dead time period, and the switching loss occurs.

Japanese Patent No. 3706852 discloses a switching power supply device capable of setting an optimum dead time. In this switching power supply device, the dead time is set to an optimum value by lengthening the dead time period when an input current and an output current decrease, or an input voltage increases, and shortening the dead time period when the input current and the output current increase or the input voltage decreases.

### SUMMARY

In the switching power supply device of Japanese Patent No. 3706852, the dead time is changed in real time according to fluctuation of either the current or the voltage. Therefore, for example, when the input voltage and the output current fluctuate at the same time, it becomes difficult to set the dead time to the optimum value.

An object of one or more embodiments of the present invention is to provide a switching power supply device capable of setting an optimum dead time even when a voltage and a current fluctuate at the same time.

In one or more embodiments of the present invention, there is provided a switching power supply device including: a converter configured to switch an input voltage input from a power supply to convert the input voltage into a predetermined voltage and supply the converted voltage to a load, the converter including: a pair of input terminals connected to the power supply; a pair of output terminals connected to the load; a switching circuit including a pair of switching elements connected in series between the input terminals, the switching circuit being configured to switch the input voltage by on/off operations of the switching elements; a rectifier circuit configured to rectify the voltage switched by the switching circuit; and a transformer disposed between the switching circuit and the rectifier circuit, the transformer including a primary winding connected to the switching circuit and a secondary winding connected to the rectifier circuit; an input voltage detecting unit configured to detect the input voltage of the converter; a current detecting unit configured to detect at least one of an input current and an output current of the converter; a dead time setting unit configured to set a dead time in on/off operations of the pair of switching elements; and a dead time table in which the dead time is recorded for each of a plurality of input voltage values and each of a plurality of output current values on a matrix formed by the plurality of the input voltage values and the plurality of the output current values, wherein the dead time setting unit sets the dead time with reference to the dead time table based on the input voltage detected by the input voltage detecting unit and the current detected by the current detecting unit.

Such a configuration enables to set the dead time to the optimum value in real time by referring to the dead time table, even when the input voltage and the output current fluctuate at the same time. Further, subdividing the matrix of the dead time table enables to switch the dead time with high resolution according to the fluctuation of the input voltage and the output current.

In one or more embodiments of the present invention, the dead time recorded in the dead time table may become longer as the input voltage value is larger and the output current value is smaller, and may become shorter as the input voltage value is smaller and the output current value is larger.

In one or more embodiments of the present invention, the dead time recorded in the dead time table may be a time period from a time point at which one of the pair of switching elements is turned off to a time point at which a voltage across the other switching element becomes zero volts.

According to one or more embodiments of the present invention, it is possible to provide the switching power supply device capable of setting the optimum dead time even when the voltage and the current fluctuate at the same time.

### BRIEF DESCRIPTION OF DRAWINGS

FIG. 1 is a diagram showing an example of a switching power supply device according to an embodiment of the present invention;

FIG. 2 is a diagram showing an example of a dead time table;

FIG. 3 is a time chart for explaining the dead time;

FIG. 4 is a circuit diagram for explaining details of the switching element;

FIG. 5 is a diagram showing a relationship between a change in the voltage of the switching element and the dead time;

FIG. 6 is a time chart for explaining a setting of the dead time according to an input voltage and an output current;

FIG. 7 is a time chart for explaining a setting of the dead time according to an input voltage and an output current;

FIG. 8 is a time chart for explaining a setting of the dead time according to an input voltage and an output current;

FIG. 9 is a time chart for explaining a setting of the dead time according to an input voltage and an output current;

FIG. 10 is a diagram showing a temporal change of a FET voltage calculated from a mathematical equation;

FIG. 11 is a diagram showing another example of the dead time table;

FIG. 12 is a diagram showing another example of the dead time table;

FIG. 13 is a diagram showing an application example of an embodiment of the present invention; and

FIG. 14 is a diagram showing an example of a switching frequency table.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Embodiments of the present invention are described with reference to the drawings. In the drawings, the same or corresponding portions are denoted by the same reference numerals.

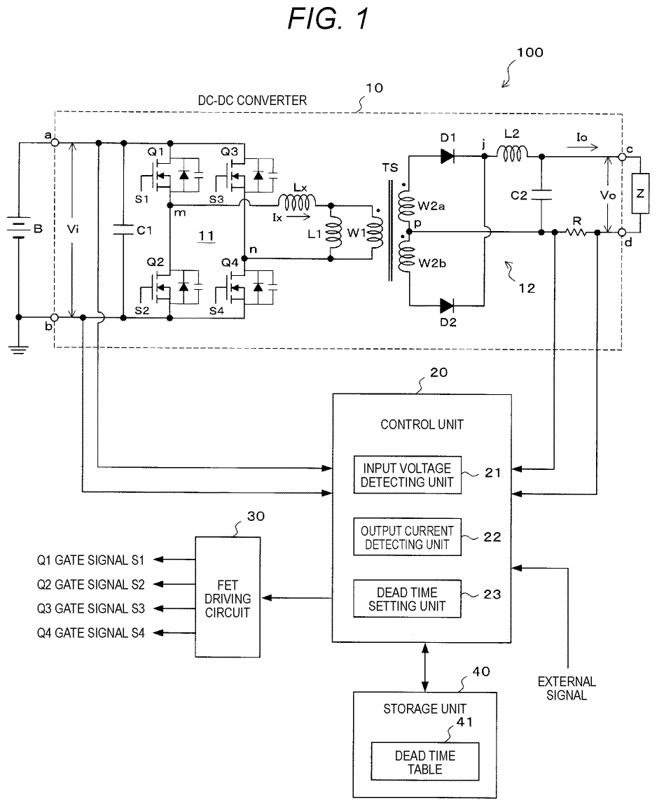

First, the configuration of the switching power supply device is explained with reference to FIG. 1. In FIG. 1, the switching power supply device 100 is configured with a DC-DC converter 10 (hereinafter simply referred to as “converter”), a control unit 20, a FET driving circuit 30, and a storage unit 40.

The converter 10 includes a pair of input terminals a, b connected to a DC power supply B and a pair of output terminals c, d connected to a load Z, and switches an input voltage Vi input from the DC power supply B to convert the input voltage Vi into a predetermined voltage and supplies the converted voltage to the load Z as an output voltage Vo. The converter 10 includes a switching circuit 11, a transformer TS, a rectifier circuit 12, a capacitor C1, a capacitor C2, an inductor L2, an inductor Lx, and a shunt resistor R.

The capacitor C1 is for removing ripple components included in the input voltage Vi, and is connected between the input terminals a, b. The switching circuit 11 is a full-bridge type switching circuit having four switching elements Q1 to Q4. A pair of switching elements Q1, Q2 are connected in series between the input terminals a, b. The other pair of switching elements Q3, Q4 are also connected in series between the input terminals a, b. In the present embodiment, these switching elements Q1 to Q4 are configured with field effect transistors (FET). As shown in FIG. 4, a parasitic diode Ds and a parasitic capacitance Cs are connected in parallel between a drain and a source of each switching element Q1 to Q4.

The transformer TS has an exciting inductor L1, a primary winding W1, and secondary windings W2a, W2b. One end of the primary winding W1 is connected to a connection point m of the switching elements Q1, Q2 through an inductor Lx for resonance, and the other end of the primary winding W1 is connected to a connection point n of the switching elements Q3, Q4. The exciting inductor L1 is built in the transformer TS and connected in parallel with the primary winding W1. The secondary windings W2a and W2b are connected to the rectifier circuit 12 configured with a diode D1 and a diode D2. The inductor L2 and the capacitor C2 constitute a smoothing circuit.

In detail, the diode D1 and the inductor L2 are connected in series between one end of the secondary winding W2a and the output terminal c, and the other end of the secondary winding W2a is connected to one end of the secondary winding W2b. The other end of the secondary winding W2b is connected to a connection point j between the diode D1 and the inductor L2 through the diode D2. The capacitor C2 is connected in parallel with the secondary winding W2a, the diode D1, and the inductor L2. The shunt resistor R is connected between the connection point p of the secondary windings W2a, W2b and the output terminal d.

The control unit 20 is configured with a CPU and the like, and has an input voltage detecting unit 21, an output current detecting unit 22, and a dead time setting unit 23. The input voltage detecting unit 21 detects a voltage between the input terminals a, b, that is, the input voltage Vi of the converter 10. The output current detecting unit 22 detects an output current Io of the converter 10 based on a voltage drop of the shunt resistor R. The dead time setting unit 23 sets a dead time in on/off operations of the switching elements Q1 to Q4. The setting of the dead time is described later in detail. An external signal is input to the control unit 20, for example, from an in-vehicle electronic control unit (ECU), and the control unit 20 performs predetermined control according to the signal.

The FET driving circuit 30 is a circuit for driving the switching circuit 11, and turns on and off the switching elements Q1 to Q4 by providing gate signals S1 to S4 to each gate of the switching elements Q1 to Q4. The gate signals S1 to S4 are, for example, pulse width modulation (PWM) signals. The FET driving circuit 30 generates a PWM signal having a predetermined duty based on a command from the control unit 20, and outputs the generated signal to the switching circuit 11 as gate signals S1 to S4.

In a case where the switching elements Q1 to Q4 perform on/off operations by the gate signals S1 to S4, as described above, when the upper and lower switching elements (Q1 and Q2, Q3 and Q4) are both turned on, the input terminals a, b are short-circuited. In order to avoid this, as shown in FIG. 3, a dead time ΔT in which both switching elements are turned off is provided between the time point at which one switching element is turned off and the time point at which the other switching element is turned on.

The storage unit 40 is configured with a semiconductor memory. In this storage unit 40, a dead time table 41 is stored in addition to a software program (not shown) for operating the control unit 20.

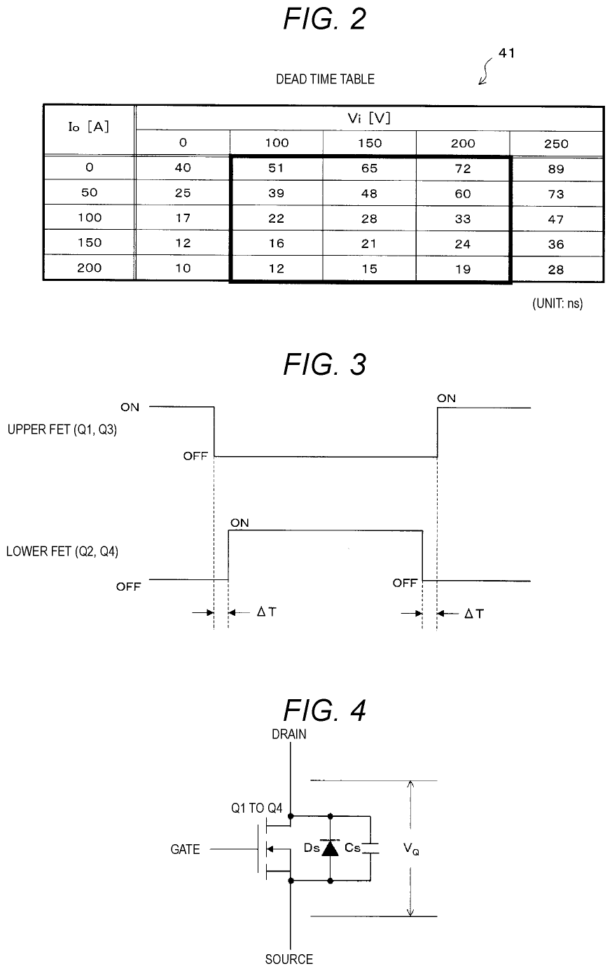

FIG. 2 schematically shows an example of the dead time table 41. The dead time table 41 records the dead time for each input voltage value and each output current value on a matrix configured with a plurality of input voltage values (Vi) and a plurality of output current values (Io). Here, for simplification, 25 dead times by a combination of five input voltage values and five output current values are illustrated. Among the dead times in the table, values in a range surrounded by a thick frame are actually used.

As can be seen from FIG. 2, the dead time recorded in the dead time table 41 is longer as the value of the input voltage Vi is larger and the value of the output current Io is smaller (that is, the higher the voltage is and the lighter the load is), and is shorter as the value of the input voltage Vi is smaller and the value of the output current Io is larger (that is, the lower the voltage is and the heavier the load is).

The dead time setting unit 23 sets the dead time ΔT with reference to the dead time table 41 based on the input voltage Vi detected by the input voltage detecting unit 21 and the output current Io detected by the output current detecting unit 22. For example, when the input voltage is Vi=150V and the output current is Io=50 A, the dead time between the upper and lower switching elements is set to ΔT=48 ns. When the input voltage is Vi=200V and the output current is Io=100 A, the dead time between the upper and lower switching elements is set to ΔT=33 ns.

The FET driving circuit 30 generates gate signals S1 to S4 (PWM signals) which turn on and off at predetermined timing according to the dead time ΔT set by the dead time setting unit 23, and drives the switching elements Q1 to Q4.

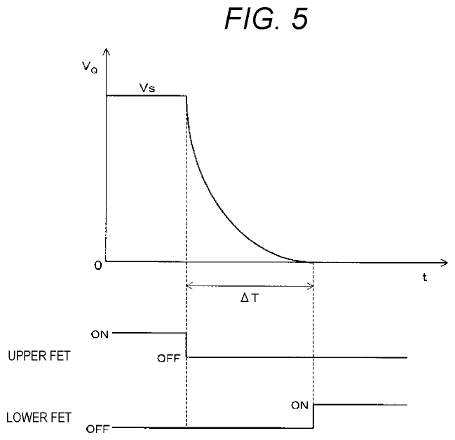

By the way, as shown in FIG. 4, a voltage V_{Q} due to charging of the parasitic capacitance Cs is applied to both ends (between the drain and the source) of the switching elements Q1 to Q4. Then, the voltage V_{Q} gradually decreases due to discharge of the parasitic capacitance Cs. This is shown in FIG. 5.

In FIG. 5, when an upper FET (for example, Q3) is turned on and a lower FET (for example, Q4) is turned off, a current flows to the parasitic capacitance Cs of the lower FET and the parasitic capacitance Cs is charged, so that a voltage of V_{Q}=Vs is applied to both ends of the lower FET. When the upper FET is turned off, the parasitic capacitance Cs of the lower FET starts to be discharged and the voltage V_{Q} across the lower FET gradually decreases from Vs. When the voltage across the lower FET becomes V_{Q}=0, the lower FET is turned on. That is, in FIG. 5, the time period from a time point at which the upper FET is turned off to a time point at which the voltage across the lower FET becomes zero volts is the dead time ΔT. The dead time ΔT determined in this manner is recorded in the dead time table 41 of FIG. 2.

Providing the dead time ΔT, as described above, enables to realize soft switching operation described above and to reduce switching loss because the current starts to flow between the drain and the source from a time point at which the voltage V_{Q} across the lower FET becomes zero volts.

Next, an example of a specific calculation method of the dead time ΔT is explained.

Transient characteristics of the voltage V_{Q} (voltage of the parasitic capacitance Cs) across the switching elements Q1 to Q4 can be approximated, for example, by the following equation.

$${V}_{Q} = Vi \cdot cos \frac{1}{\sqrt{2 L x C s}} t - Ix \cdot \sqrt{\frac{L x}{2 C s}} \cdot sin \frac{1}{\sqrt{2 LxCs}} t \qquad ( 1 )$$

Here, Vi is the input voltage, Lx is an inductance value of the inductor Lx, Cs is a capacitance value of the parasitic capacitance Cs, Ix is a current flowing through the inductor Lx, and t is time. As described above, the time t when V_{Q}=0 is the dead time ΔT. The above equation (1) is an example of an approximate equation, and other approximate equations may be used.

Assuming that the time t is sufficiently smaller than a vibration cycle of the voltage V_{Q}, the dead time ΔT can be obtained from the following approximate equation.

$$t = \frac{- \frac{2 L x I x}{Vi} + \sqrt{{( \frac{2 L x I x}{Vi} )}^{2} + 16 L x C s}}{2} \qquad ( 2 )$$

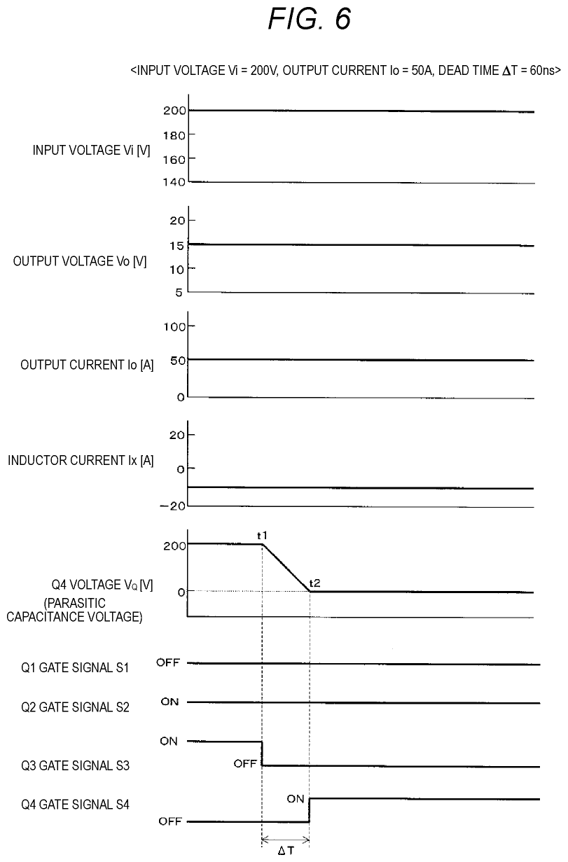

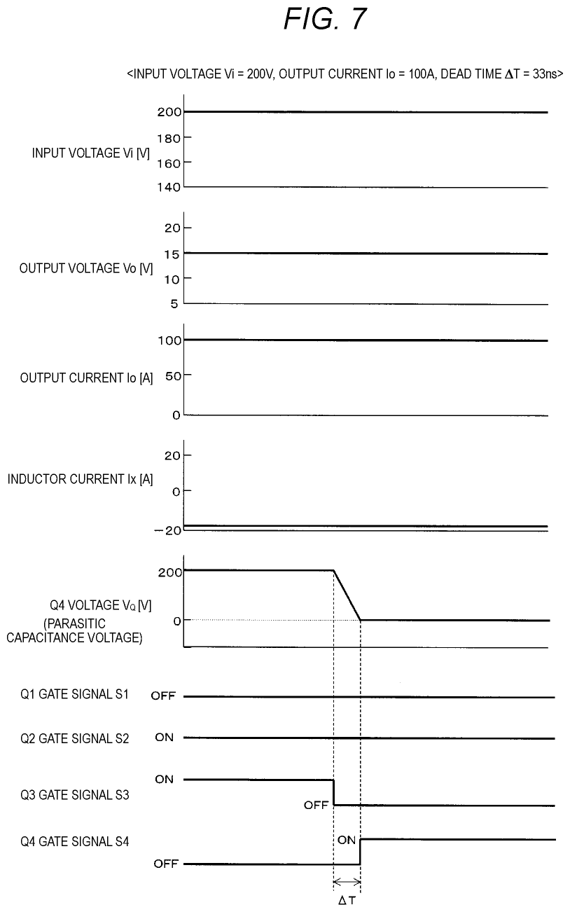

FIGS. 6 to 9 show examples of setting the dead time ΔT according to the input voltage Vi and the output current Io. Each figure shows the input voltage Vi, the output voltage Vo, the output current Io, an inductor current Ix, the voltage across the switching element Q4 (parasitic capacitance voltage), and the gate signals S1 to S4. Here, the dead time ΔT between the switching elements Q3 and Q4 is taken as an example. In FIG. 6, since the parasitic capacitance Cs (FIG. 2) of the switching element Q4 starts to be discharged from the time t1 when the switching element Q3 is turned off, the voltage V_{Q} across the switching element Q4 decreases and the switching element Q4 is turned on at the time t2 when V_{Q}=0, as in the case of FIG. 5. A period from t1 to t2 is the dead time ΔT. The same applies to FIGS. 7 to 9.

FIG. 6 shows a case where the input voltage Vi is 200V and the output current Io is 50 A. The dead time ΔT when Vi=200V and Io=50 A is ΔT=60 ns from the dead time table 41 of FIG. 2. FIG. 6 shows a case of “high voltage and light load” where the input voltage Vi is high and the output current Io is small, and the dead time ΔT is relatively long. When the dead time ΔT becomes long, an on-period of the switching element Q4 becomes short, and it becomes possible to cope with a light load.

FIG. 7 shows a case where the input voltage Vi is 200V and the output current Io is 100 A. The dead time ΔT when Vi=200V and Io=100 A is ΔT=33 ns from the dead time table 41 of FIG. 2. In FIG. 7, a value of the output current Io is larger than that in FIG. 6. That is, FIG. 7 shows a case of “high voltage and heavy load” where the input voltage Vi is high and the output current Io is large, and a value of the dead time ΔT is shorter than that in FIG. 6. The shorter the dead time ΔT is, the longer the on-period of the switching element Q4 is, so that it becomes possible to cope with the heavy load.

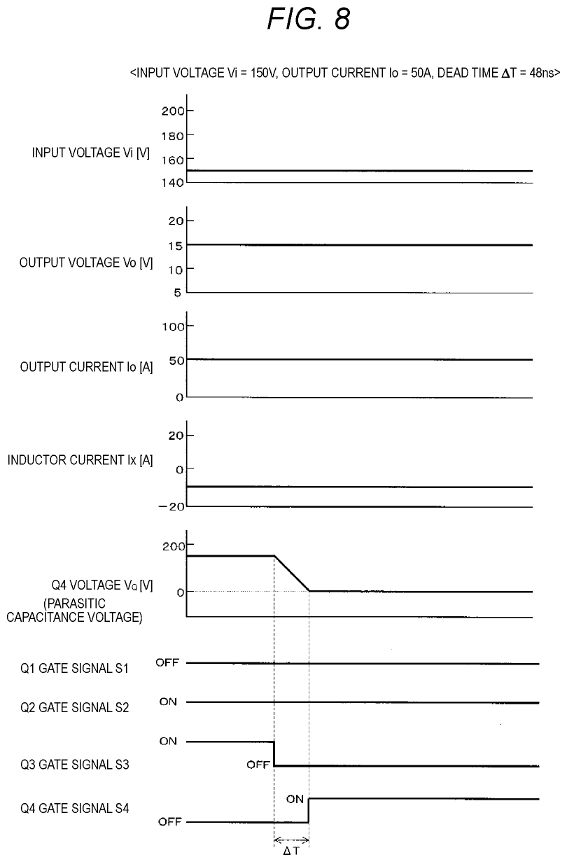

FIG. 8 shows a case where the input voltage Vi is 150V and the output current Io is 50 A. The dead time ΔT when Vi=150V and Io=50 A is ΔT=48 ns from the dead time table 41 of FIG. 2. In FIG. 8, both the input voltage Vi and the output current Io are smaller than those in FIG. 7. That is, FIG. 8 shows a case of “low voltage and light load”, and a value of the dead time ΔT is longer than that in FIG. 7. When the dead time ΔT becomes long, the on-period of the switching element Q4 becomes short, and it becomes possible to cope with the light load.

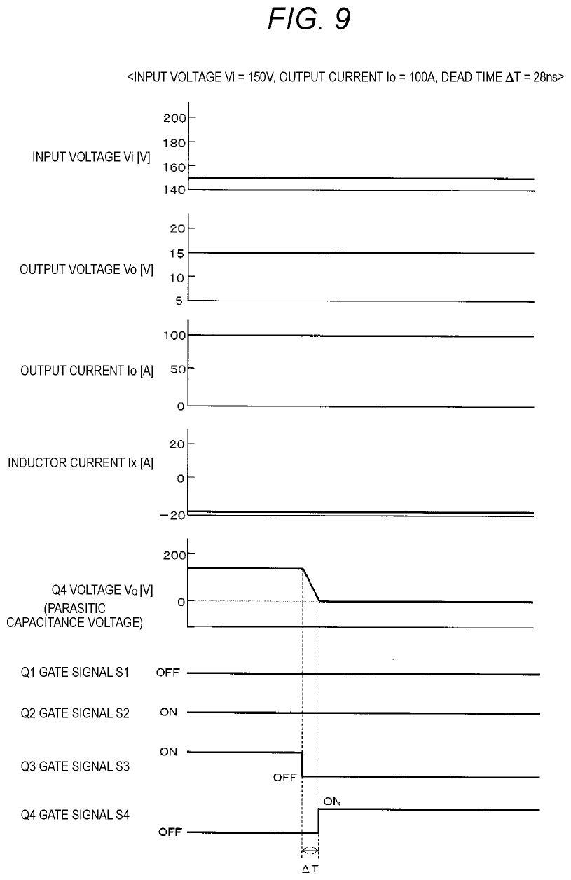

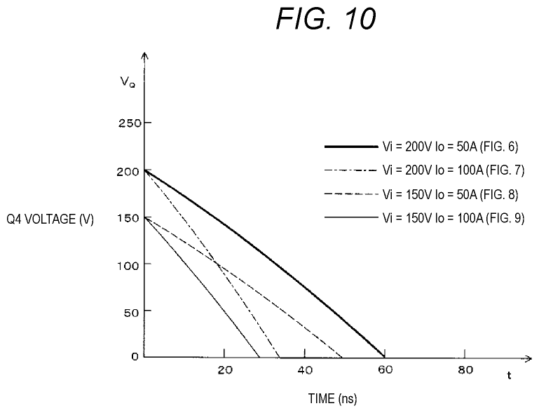

FIG. 9 shows a case where the input voltage Vi is 150V and the output current Io is 100 A. The dead time ΔT when Vi=150V and Io=100 A is ΔT=28 ns from the dead time table 41 of FIG. 2. In FIG. 9, a value of the output current Io is larger than that in FIG. 8. That is, FIG. 9 shows a case of “low voltage and heavy load”, and a value of the dead time ΔT is shorter than that in FIG. 8. When the dead time ΔT becomes short, the on-period of the switching element Q4 becomes long, and it becomes possible to cope with the heavy load.

FIG. 10 is a graph showing a temporal change of the voltage V_{Q} across the switching element Q4 calculated from the above equation (1). Here, a state of change in V_{Q} is shown for each of the cases of FIGS. 6 to 9 described above. As can be seen from FIG. 10, the dead time (time t until becoming V_{Q}=0) becomes longer as it becomes “high voltage and light load” (FIG. 6), and shorter as it becomes “low voltage and heavy load” (FIG. 9). Further, the dead time in the case of “high voltage and heavy load” (FIG. 7) becomes shorter than that in the case of “low voltage and light load” (FIG. 8).

According to the embodiment described above, the dead time table 41 in which the dead time is recorded for each voltage and each current on the matrix of the input voltage and the output current is provided, and the dead time setting unit 23 sets the dead time ΔT with reference to the dead time table 41 based on the input voltage Vi detected by the input voltage detecting unit 21 and the output current Io detected by the output current detecting unit 22. Therefore, referring to the dead time table 41 enables to set the dead time ΔT to the optimum value in real time, even when the input voltage Vi and the output current Io fluctuate at the same time. Further, subdividing the matrix of the dead time table 41 enables to switch the dead time ΔT with high resolution according to the fluctuation of the input voltage Vi and the output current Io.

The dead time recorded in the dead time table 41 becomes longer as the input voltage Vi is larger and the output current Io is smaller, and becomes shorter as the input voltage Vi is smaller and the output current Io is larger. Therefore, it is possible to appropriately cope with the case of high voltage and light load or low voltage and heavy load.

Further, the dead time recorded in the dead time table 41, which uses the FET having the parasitic capacitance Cs between the drain and the source as the switching elements Q1 to Q4, is the time period from a time point at which one of the pair of switching elements is turned off to a time point at which a voltage V_{Q} (voltage of the parasitic capacitance Cs) across the other switching element becomes zero volts (see FIG. 5). Providing the dead time, as described above, enables to realize the soft switching operation in which the switching element is turned on after the voltage V_{Q} becomes zero volts and to reduce the switching loss.

In the present invention, various embodiments can be employed in addition to the above-described embodiments.

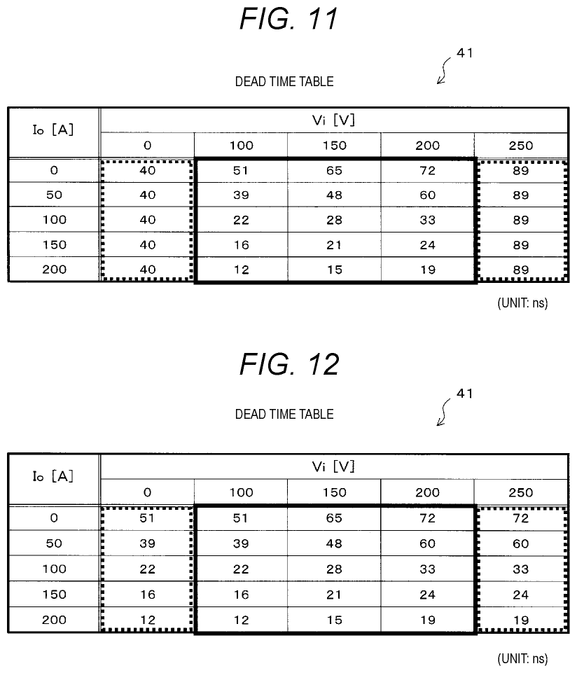

For example, in the dead time table 41 of FIG. 2, the value of the dead time outside the thick frame may be set to a fixed value as indicated by the dotted line frame of FIG. 11. In this case, the fixed value is preferably set to a safe side (large value) from a viewpoint of short circuit prevention between the input terminals a, b, and the like. Also, in the dead time table 41 of FIG. 2, the value of the dead time outside the thick frame may be set to a saturation value (the same value as the adjacent value) as indicated by the dotted line frame of FIG. 12.

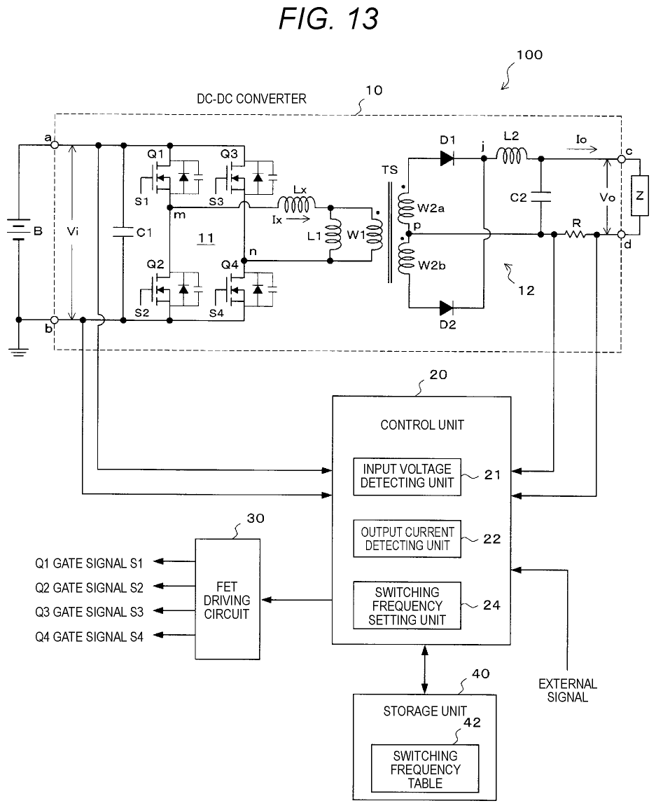

In the above embodiment, the switching of the dead time according to the input voltage Vi and the output current Io is described, and a principle of the present invention can also be applied to switching of a switching frequency according to the input voltage Vi and the output current Io. FIG. 13 shows a configuration example in this case. In FIG. 13, a switching frequency setting unit 24 is provided instead of the dead time setting unit 23 of FIG. 1, and a switching frequency table 42 is provided instead of the dead time table 41 of FIG. 1. Other configurations are the same as shown in FIG. 1.

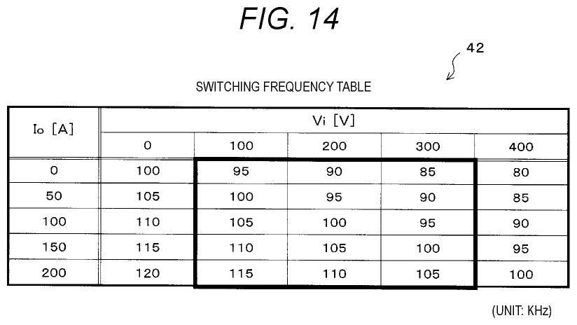

FIG. 14 shows an example of the switching frequency table 42. The switching frequency is set to a lower value as the voltage becomes higher (Vi is larger) and the load becomes lighter (Io is smaller). Among the switching frequencies in the table, values in a range surrounded by a thick frame are actually used. The switching frequency setting unit 24 sets an optimum switching frequency with reference to the switching frequency table 42 based on the input voltage Vi detected by the input voltage detecting unit 21 and the output current Io detected by the output current detecting unit 22.

In FIG. 14, the value of the switching frequency outside the thick frame may be set to a fixed value as in FIG. 11. In this case, the fixed value is preferably set to the safe side (large value) from a viewpoint of prevention of magnetic saturation of the transformer TS and the like. Also, the value of the dead time outside the thick frame may be set to the saturation value (the same value as the adjacent value) as shown in FIG. 12.

Although an example in which the switching frequency table 42 is provided instead of the dead time table 41 of FIG. 1 is taken in FIG. 13, the switching frequency table 42 may be provided in addition to the dead time table 41 of FIG. 1. That is, providing both the dead time table 41 and the switching frequency table 42 may enable to set the dead time and the switching frequency to optimum values, respectively.

Although an example in which the output current detecting unit 22 for detecting the output current Io is provided is taken in the above embodiment, since the output current Io can be calculated from the input current, an input current detecting unit (not shown) for detecting an input current may be provided and the output current Io may be calculated by calculation from the detected current value. For example, the current Ix flowing through the inductor Lx in FIG. 1 may be detected as the input current. In this case, the output current Io can be calculated as Io≈Ix·γ when the turns ratio of the transformer TS is γ. Therefore, a current detecting unit for detecting at least one of the input current and the output current may be provided.

Although an example in which the input voltage detecting unit 21, the output current detecting unit 22, and the dead time setting unit 23 are provided in the control unit 20 is taken in the above embodiment, each of these units may be provided separately from the control unit 20. Also, although an example in which the dead time table 41 is provided in the storage unit 40 is taken in the above embodiment, the dead time table 41 may be provided in the control unit 20. Further, the FET driving circuit 30 may be provided in the control unit 20.

Although the DC-DC converter 10 is taken as an example of the converter in the above embodiment, the converter is not limited to the DC-DC converter and may be, for example, an AC-DC converter. In this case, processing is performed such that an input AC voltage is converted into a DC voltage, the converted DC voltage is switched and converted into an AC voltage, and the AC voltage is further rectified and converted into a DC voltage.

Although the full-bridge type switching circuit having four switching elements Q1 to Q4 is taken as an example of the switching circuit 11 in the above embodiment, the switching circuit may be a half-bridge type switching circuit having two switching elements.

Although the FET is taken as an example of the switching elements Q1 to Q4 in the above embodiment, a bipolar type general transistor may be used for the switching elements Q1 to Q4. In this case, a diode and a capacitor as circuit components may be connected in parallel with the transistor, instead of the parasitic diode Ds and the parasitic capacitance Cs. An IGBT or the like may be used as the switching elements Q1 to Q4.

Although an example in which the shunt resistor R is provided in order to detect the output current Io is taken in the above embodiment, a hall element or the like may be provided instead of the shunt resistor R.

Although an example in which the switching elements Q1 to Q4 are driven by the PWM signal is taken in the above embodiment, the switching elements Q1 to Q4 may also be driven by a drive signal other than the PWM signal.

Although an example in which the switching power supply device mounted on a vehicle is taken in the above embodiment, the present invention can also be applied to a switching power supply device used in a field other than the vehicle.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A switching power supply device comprising:
a converter configured to switch an input voltage input from a power supply to convert the input voltage into a predetermined voltage and supply the converted voltage to a load, the converter comprising:
a pair of input terminals connected to the power supply;
a pair of output terminals connected to the load;
a switching circuit comprising a pair of switching elements connected in series between the input terminals, the switching circuit being configured to switch the input voltage by on/off operations of the switching elements;
a rectifier circuit configured to rectify the voltage switched by the switching circuit; and
a transformer disposed between the switching circuit and the rectifier circuit, the transformer comprising a primary winding connected to the switching circuit and a secondary winding connected to the rectifier circuit;
an input voltage detecting unit configured to detect the input voltage of the converter;
a current detecting unit configured to detect at least one of an input current and an output current of the converter;
a dead time setting unit configured to set a dead time in on/off operations of the pair of switching elements; and
a dead time table in which the dead time is recorded for each of a plurality of input voltage values and each of a plurality of output current values on a matrix formed by the plurality of the input voltage values and the plurality of the output current values,
wherein the dead time setting unit sets the dead time with reference to the dead time table based on the input voltage detected by the input voltage detecting unit and the current detected by the current detecting unit.

2. The switching power supply device according to claim 1,
wherein the dead time recorded in the dead time table becomes longer as the input voltage value is larger and the output current value is smaller, and becomes shorter as the input voltage value is smaller and the output current value is larger.

3. The switching power supply device according to claim 1,
wherein the dead time recorded in the dead time table is a time period from a time point at which one of the pair of switching elements is turned off to a time point at which a voltage across the other of the pair of switching elements becomes zero volts.
